(19) United States
(12) Patent Application Publication
(10) Pub. No.: US 2025/0252821 A1
(43) Pub. Date: Aug. 7, 2025

(54) GAME SYSTEM CAPABLE OF DETERMINING USE TIME

(71) Applicant: JUMBO TECHNOLOGY CO., LTD., TAICHUNG (TW)

(72) Inventors: Shun Tsung HSU, TAICHUNG (TW); Chang Yi WANG, TAICHUNG (TW)

(21) Appl. No.: 18/845,728

(22) PCT Filed: Apr. 20, 2022
(86) PCT No.: PCT/CN2022/087929

§ 371 Date: Apr. 25, 2025

(51) Int. Cl. G07F 17/32; G07F 17/34

(52) U.S. Cl. CPC G07F 17/3267; G07F 17/3213; G07F 17/3225; G07F 17/34

(57) ABSTRACT

The present invention relates to a game system capable of determining use time. Any one of a plurality of props is generated by a game result generation unit according to a probability, and a storage unit is caused to record any one of the generated props, or a member management unit is caused to select, according to a consumption record and a given rule, at least one of the plurality of props to be stored into a piece of account data, and the prop recorded in the account data is transferred to the storage unit, the plurality of props each having a specified game effect; moreover, when a control unit determines that a player uses at least one prop recorded in the storage unit, a corresponding specified game effect will be generated, and the used prop is deleted from the storage unit. According to the present invention, the props having different specified game effects can be collected, and the player can freely select use time, so that the player can wait for optimal use time, the effect of continuously using the game system is achieved, and the turnover of the game system can be effectively increased.

### FIELD OF THE INVENTION

The invention relates to a game system, more particularly to a game system capable of determining use time.

### BACKGROUND OF THE INVENTION

Please refer to FIG. 1. A slot machine 1 is a popular game machine. The slot machine 1 has a plurality of rollers 2. Players can start spinning the rollers 2 after placing bets. Points can be obtained based on the arrangement of symbols formed after the rollers 2 stop. The gameplay is simple and a variety of game rules and gameplays can be formulated according to the needs and preferences of players to meet the preferences of different players.

In a commonly known game rule, when a specific symbol appears or preset conditions are met, a bonus game of a certain number of rounds can be played. The bonus game is characterized by free spin, which enables players to obtain additional bonus points without spending additional cost, which is one of the important features that attracts players to use the slot machine.

In common bonus games, different gameplays are disclosed, such as the process shown in FIG. 4 of U.S. Pat. No. 8,197,328 enables respin of the rollers; and U.S. Pat. No. 10,629,030 B2 discloses a gameplay for determining the points of mystery symbols based on collected configurable symbols.

However, in conventional game systems, once a specific symbol is obtained or the symbols are collected to meet preset conditions, the bonus is rendered immediately, and the use time cannot be selected. Therefore, the player is likely to end the game after receiving the bonus, which causes a breakpoint in the game, and cannot increase the player's desire to continue using the game system.

### SUMMARY OF THE INVENTION

A main object of the invention is to provide a game system capable of determining use time, enabling a player to decide the time of use in a game, and causing the player to have the desire of using the game system continuously.

In order to achieve the above object, the invention is a game system capable of determining use time. In a first embodiment, the game system provides a slot game, the slot game provides at least one round of game for a player to play based on an operation of the player. The game system comprises a display unit, a game result generating unit, a storage unit and a control unit. The display unit is provided with a game screen displaying a real-time game image of the at least one round of game, and the game screen has a plurality of display positions arranged in matrices. The game result generating unit generates a plurality of game symbols in the at least one round of game, wherein the plurality of game symbols are displayed at the plurality of display positions of the game screen, the plurality of game symbols are provided with any one of a plurality of props according to a probability, and each of the plurality of props has a specified game effect. The storage unit is configured to record any one of the plurality of props generated in the at least one round of game. The control unit is connected to the display unit, the game result generating unit and the storage unit, and when the at least one round of game performed in sequence, the control unit performing following steps in each of the rounds of game:
performing a step of determining whether at least one of the plurality of props recorded in the storage unit is used; and
   performing a step of using the at least one of props when the player using at least one of the plurality of props recorded in the storage unit, and performing a step of performing a normal game when the player being not using the props;
   in the step of using the at least one of the plurality of props, the control unit further performing following steps:
      deleting the at least one of the plurality of props in the storage unit;
      generating the specified game effect corresponding to the prop which is used, and generating the game symbols through the game result generating unit simultaneously; and
      paying out and ending the round of game;
   in the step of performing the normal game, the control unit further performing following steps:
      determining whether generating the plurality of game symbols through the game result generating unit, if no, ending the round of game, if yes, proceeding to a next step;
      generating the plurality of game symbols through the game result generating unit;
      determining whether any one of newly generated game symbols having at least one of the plurality of props, if yes, performing a step of recording the at least one of the plurality of props of the newly generated game symbols through the storage unit, if no, proceeding to a next step; and
      paying out and ending the round of game.

In a second embodiment, in addition to the display unit, the game result generating unit, the storage unit and the control unit, the game system further comprises a member management unit, wherein the member management unit is configured to establish a member account of the player, wherein the member account comprises a consumption record and an account data of the player, and the member management unit selects at least one of a plurality of props to be stored in the account data based on the consumption record and a rendering rule, the plurality of props respectively have a specified game effect.

The control unit is connected to the member management unit, the display unit, the game result generating unit and the storage unit, and when the at least one round of game is performed in sequence, the control unit performing following steps in each of the rounds of game:
transferring the plurality of props recorded in the account data to the storage unit;
   performing a step of determining whether at least one of the plurality of props recorded in the storage unit is used;
   performing a step of using the at least one of props when the player using at least one of the plurality of props recorded in the storage unit, and performing a step of performing a normal game when the player being not using the props; and
   transferring the props recorded in the storage unit to the account data after ending the round of game;
   in the step of using the at least one of the plurality of props, the control unit further performing following steps:
      deleting the at least one of the plurality of props in the storage unit;
      generating the specified game effect corresponding to the prop which is used, generating the game symbols through the game result generating unit simultaneously; and
      paying out and ending the round of game;
   in the step of performing the normal game, the control unit further performing following steps:
      determining whether generating the plurality of game symbols through the game result generating unit, if no, ending the round of game, if yes, proceeding to a next step;
      generating the plurality of game symbols through the game result generating unit; and
      paying out and ending the round of game.

In a third embodiment, compared with the second embodiment, a main difference is that timings of transferring the props recorded in the account data to the storage unit and transferring the props recorded in the storage unit to the account data are different. More specifically, in the third embodiment, the control unit transfers the props recorded in the account data to the storage unit before a first round of the at least one round of game starts, and the control unit transfers the props recorded in the storage unit to the account data after a last round of the at least one round of game ends.

In the third embodiment, when the at least one round of game is performed in sequence, the control unit performing following steps in each of the rounds of game:
performing a step of determining whether at least one of the plurality of props recorded in the storage unit is used; and
   performing a step of using the at least one of props when the player using at least one of the plurality of props recorded in the storage unit, and performing a step of performing a normal game when the player being not using the props.

In the third embodiment, the step of using the props and the normal game step can be referred to the description in the second embodiment.

Summing up the above, the invention is capable of collecting the props with the different specified game effects, and enables the player to freely choose use time according to needs to avoid breakpoints in the game, so the player will wait for an optimal use time, thereby providing an effect of using the game system continuously, and effectively increasing a turnover of the game system.

### BRIEF DESCRIPTION OF THE DRAWINGS

FIG. 1 is a perspective view of a conventional slot machine.

FIG. 2 is a perspective view of a game machine of the invention.

FIG. 3 is a system block diagram of a first embodiment of the invention.

FIG. 4 is a flow chart of each round of game of the first embodiment of the invention.

FIGS. 5A-5D are schematic diagrams of game screens of the first embodiment of the invention.

FIG. 6 is a system block diagram of a second embodiment of the invention.

FIG. 7 is a flow chart of each round of game of the second embodiment of the invention.

FIG. 8 is a flow chart of each round of game of a third embodiment of the invention.

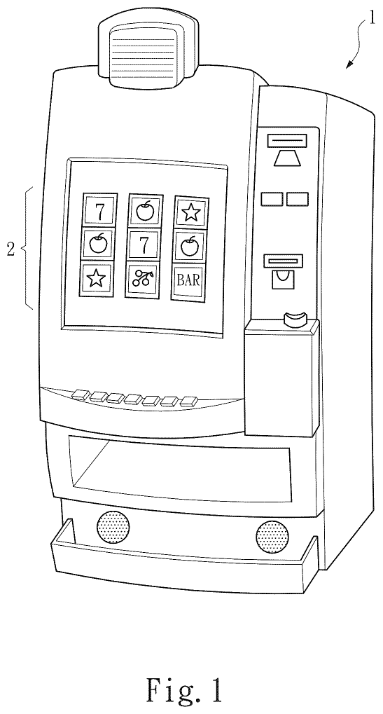

### DETAILED DESCRIPTION OF THE PREFERRED EMBODIMENTS

The detailed description and technical content of the invention are described below with reference to the accompanying drawings.

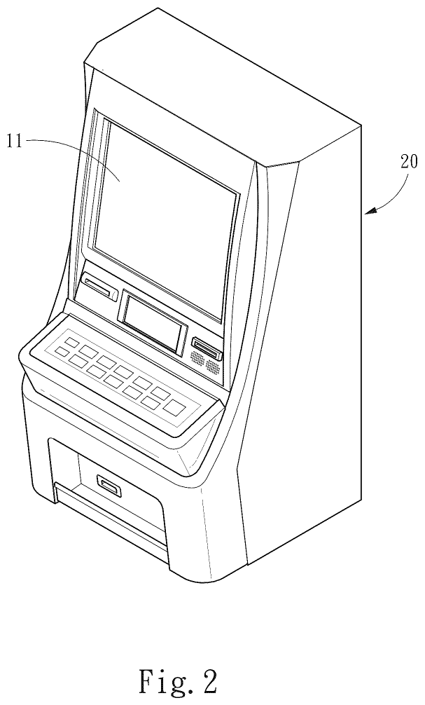

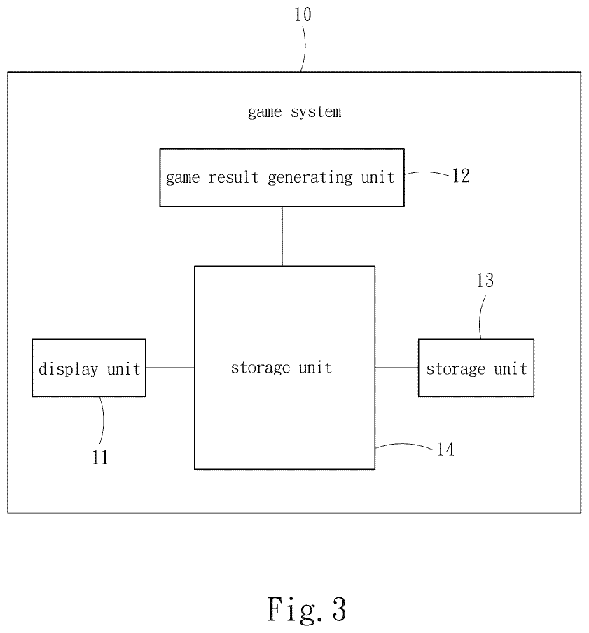

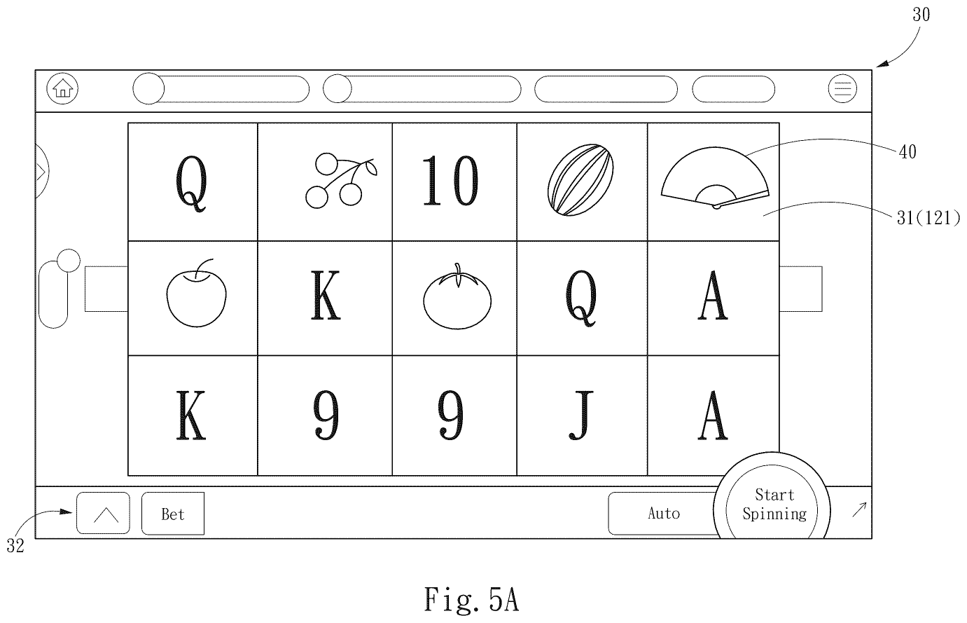

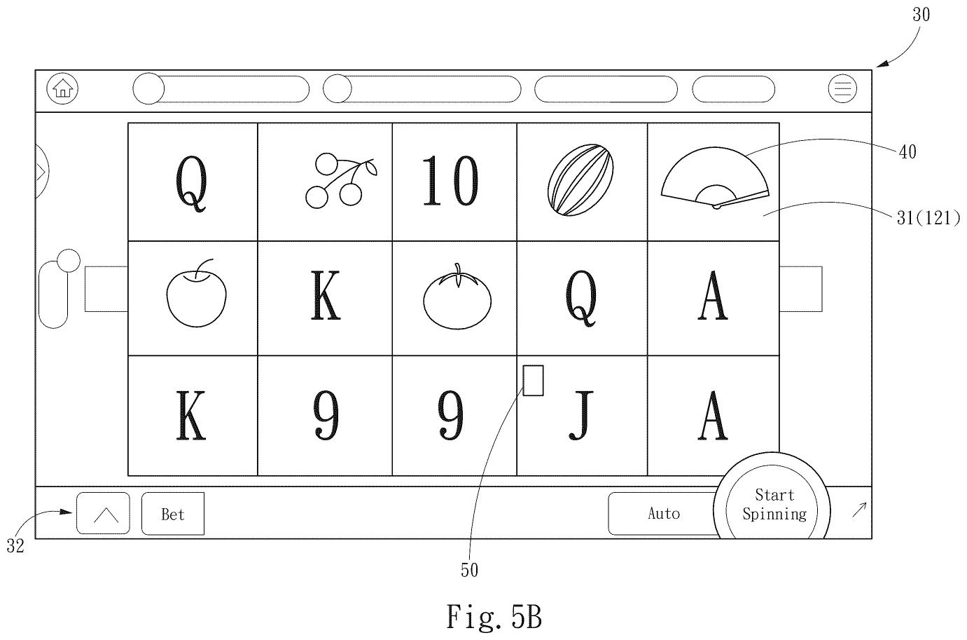

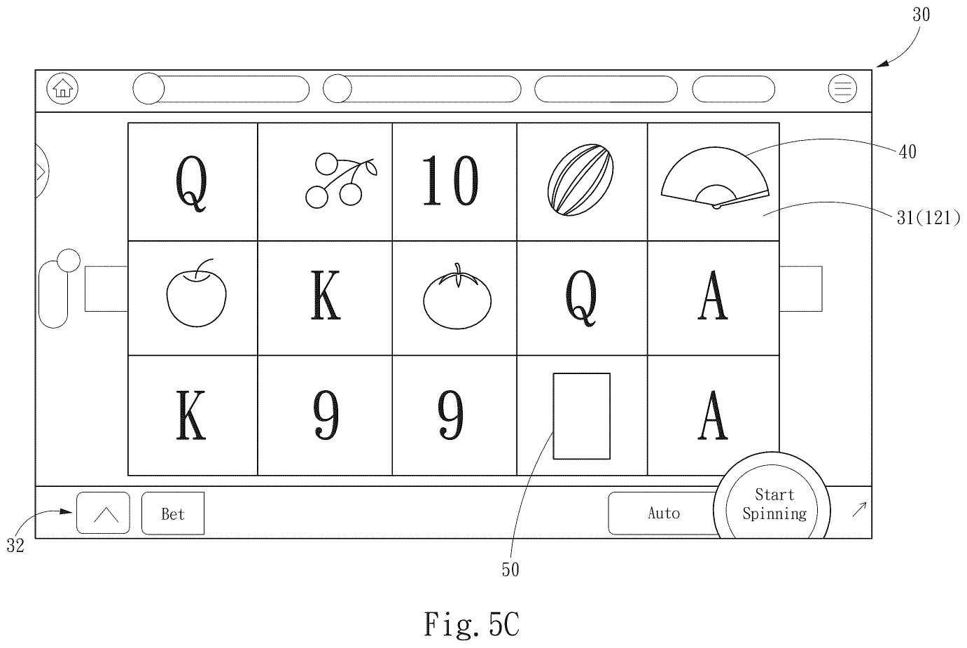

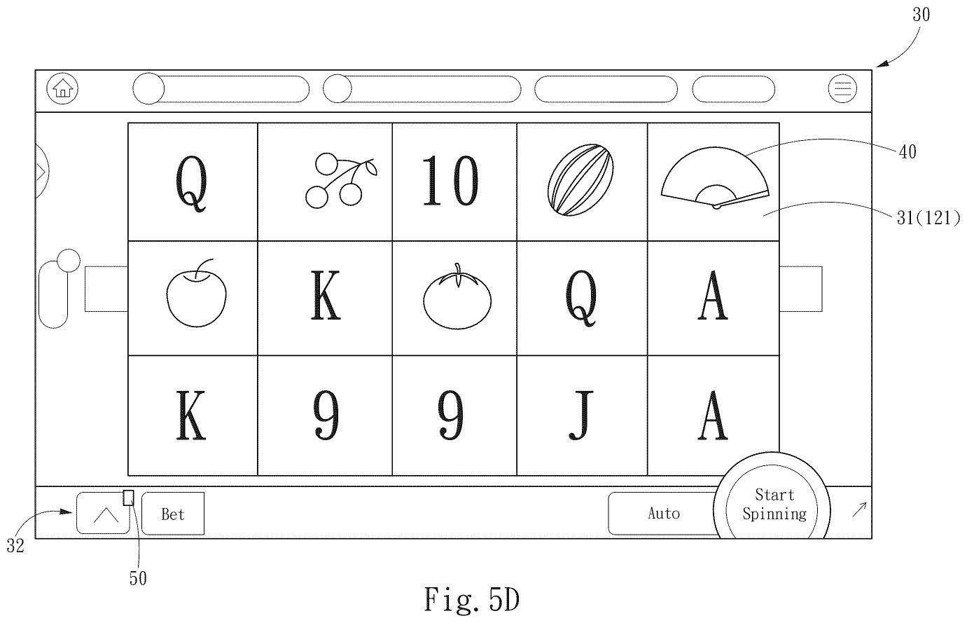

Please refer to FIG. 2, FIG. 3, FIG. 5A and FIG. 5B for a first embodiment of the invention. In this embodiment, the invention provides a game system 10 capable of determining use time. The game system 10 is installed in a game machine 20, and the game system 10 provides a slot game through the game machine 20. The slot game provides at least one round of game for a player to play based on an operation of the player. The game system 10 comprises a display unit 11, a game result generating unit 12, a storage unit 13 and a control unit 14. The display unit 11 has a game screen 30, and the game screen 30 displays a real-time game image of the at least one round of game. The game screen 30 has a plurality of display positions 31 arranged in matrices.

The slot game generates a plurality of game symbols 40 in the at least one round of game through the game result generating unit 12. The plurality of game symbols 40 are respectively displayed at the plurality of display positions 31 of the game screen 30 to determine a game result. The plurality of game symbols 40 are provided with any one of a plurality of props (items) 50 according to a probability (as shown in FIG. 5B), and the plurality of props 50 respectively have a specified game effect. The storage unit 13 is configured to record any one of the plurality of props 50 generated in the at least one round of game. In addition, the plurality of props 50 can also be obtained in other ways. In one embodiment, the control unit 14 determines that when a specified rule is satisfied in the slot game, the player can obtain at least one of the plurality of props 50 to be recorded in the storage unit 13, wherein the specified rule could be that the plurality of game symbols 40 are arranged in a special arrangement, or event rule is complied, or promotional gifts are provided.

In one embodiment, the game result generating unit 12 is implemented as a plurality of roller units 121, and the plurality of roller units 121 generate the plurality of game symbols 40 by spinning and then stopping. In a feasible embodiment, a quantity of the plurality of roller units 121 corresponds to a quantity of the plurality of display positions 31, that is, each of the plurality of display positions 31 is provided with one of the plurality of roller units 121, and each of the plurality of roller units 121 independently generates one of the plurality of game symbols 40. In another embodiment, the plurality of game symbols 40 displayed on the display positions 31 in a same row are generated by one of the plurality of roller unit 121. That is, the plurality of game symbols 40 in a same column are displayed by continuously spinning from top to bottom. For example, if the game screen 30 comprises the plurality of display positions 31 arranged in a 3×5 matrix to display the plurality of game symbols 40, the embodiment is implemented with five of the roller units 121, that is, each roller unit 121 simultaneously displays three rows of the game symbols 40 on the game screen 30. When spinning, the game symbols 40 will move from a first row to a second row, finally move to a third row, and then disappear from the game screen 30.

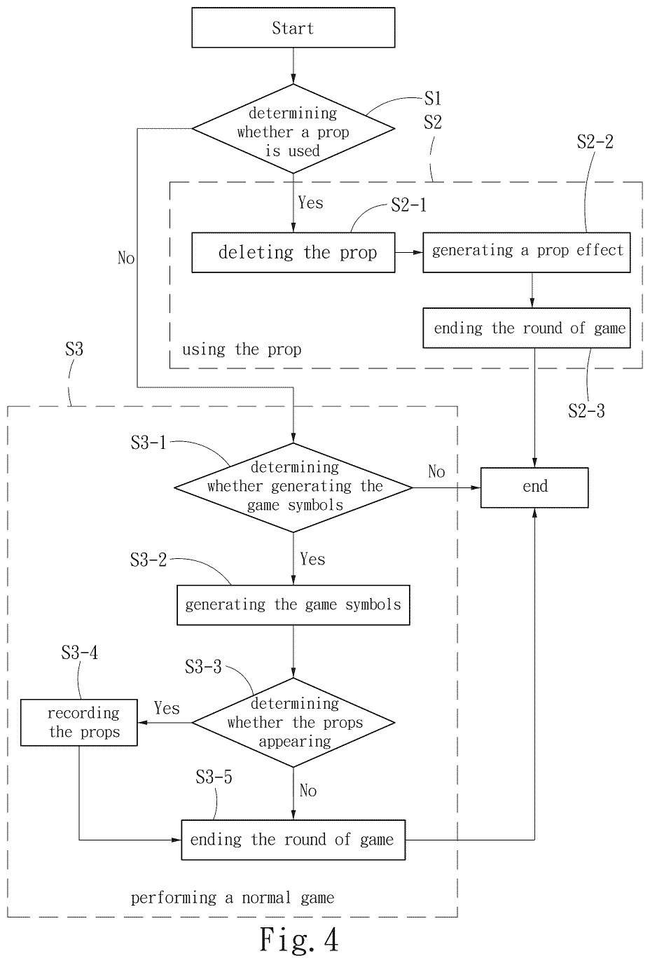

Please refer to FIG. 3 and FIG. 4. The control unit 14 is connected to the display unit 11, the game result generating unit 12 and the storage unit 13. When the at least one round of game is performed in sequence, the control unit 14 performing following steps.

Firstly, performing a step S1 of determining whether a prop is used, in this step, determining whether the player using at least one of the plurality of props 50 recorded in the storage unit 13; and
performing a step S2 of using the prop when the player use the at least one of the plurality of props 50 recorded in the storage unit 13, and performing a step S3 of performing a normal game when the player does not use the at least one of the plurality of props 50.

In the step S2 of using the prop, the control unit 14 further performing following steps:
step S2-1: deleting the prop. In this step, deleting a recordation of the at least one of the plurality of props 50 in the storage unit 13;
step S2-2: generating a prop effect. In this step, generating the specified game effect corresponding to the prop which is used, and generating the game symbols 40 through the game result generating unit 12 simultaneously; and
step S2-3: ending the round of game. In this step, paying out and ending the round of game. According to embodiments of the game system, each of the plurality of props 50 have multiple functions and uses. For example, one of the plurality of props 50 can be used alone to produce the corresponding specified game effect; or the plurality of props 50 are presented in the form of fragments, wherein the related props 50 belong to a same group, and the specified props 50 need to be combined to produce the corresponding specified game effect; alternatively, the plurality of props 50 can be used individually or can be combined for using, when the plurality of props 50 are combined for using, an effect is increased to produce the specified game effect with different levels.

In the step S3 of performing the normal game, the control unit 14 further performing following steps:
step S3-1: determining whether generating the game symbols. In this step, determining whether generating the plurality of game symbols 40 through the game result generating unit 12, if no, ending the round of game; if yes, proceeding to a next step;
step S3-2: generating the game symbols. In this step, generating the plurality of game symbols 40 through the game result generating unit 12;
step S3-3: determining whether the props appearing. In this step, determining whether any one of the plurality of game symbols 40 which is newly generated having at least one of the plurality of props 50, if no, ending the round of game; if yes, proceeding to a next step;
step S3-4: recording the props. In this step, recording the at least one of the plurality of props 50 newly generated through the storage unit 13; and
step S3-5: ending the round of game. In this step, paying out and ending the round of game.

Please refer to FIG. 3 and FIGS. 5A-5D for the first embodiment of the invention. Firstly, as shown in FIG. 5A, when performing the at least one round of game, the plurality of roller units 121 of the game result generating unit 12 generates the plurality of game symbols 40 by spinning and then stopping.

Then, as shown in FIG. 5B, when performing the at least one round of game, the plurality of game symbols 40 are provided with any one of the plurality of props 50 according to the probability. Patterns of the plurality of props 50 are determined according to designs of the game, and the plurality of props 50 with different game effects have different representative patterns.

There is no certain mode in which the plurality of props 50 appear. For example, the prop 50 can be an independent pattern and can be movably attached to any one of the game symbols 40, as shown in FIG. 5B. Or the prop 50 can also be directly combined with the game symbol 40, that is, the prop 50 will appear through the roller unit 121 along with the same game symbol 40.

Then, as shown in FIG. 5C, when any one of the plurality of props 50 appears, the prop 50 can be enlarged in size to enable the player clearly know a type of the prop 50 collected.

Then, as shown in FIG. 5D, when any one of the plurality of props 50 is collected, the prop 50 is recorded in the storage unit 13. In order to indicate that the storage unit 13 has recorded the prop 50, the prop 50 can be moved to a functional operation area 32 of the game screen 30 to show that the prop 50 has been stored in the storage unit 13.

In addition, the player can have a member account which comprises an account data, and the account data is able to record the plurality of props 50. The plurality of props 50 recorded in the account data can be transferred to the storage unit 13, and the plurality of props 50 recorded in the storage unit 13 can also be transferred to the account data. The control unit 14 transfers the plurality of props 50 recorded in the account data to the storage unit 13 before a first round of the at least one round of game starts, and the control unit 14 transfers the plurality of props 50 recorded in the storage unit 13 to the account data after a last round of the at least one round of game ends. The plurality of props 50 can be collected by the player in segments, which can increase the player's desire to play in sporadic time.

In another embodiment, the control unit 14 transfers the plurality of props 50 recorded in the account data to the storage unit 13 during each of the rounds of game, and the control unit 14 transfers the plurality of props 50 recorded in the storage unit 13 to the account data when each of the rounds of game ends. That is, the plurality of props 50 are transferred at a beginning and an end of each of the rounds of game to avoid the risk of losing the props 50 recorded in the storage unit 13.

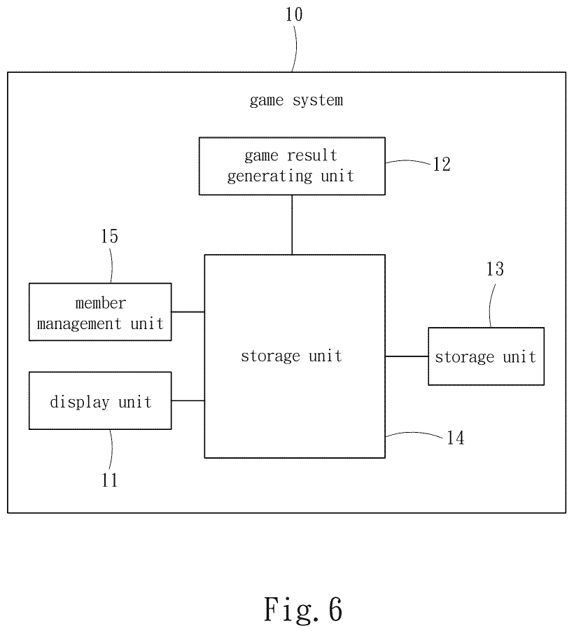

Please refer to FIG. 2 and FIG. 6 for a second embodiment of the invention. In the embodiment, the game system 10 comprises the display unit 11, the game result generating unit 12, the storage unit 13 and the control unit 14, and further comprises a member management unit 15, wherein the member management unit 15 is provided for the player to establish the member account. The member account comprises the account data of the player, and further comprises a consumption record. The member management unit 15 selects at least one of the plurality of props 50 to be stored in the account data based on the consumption record and a rendering rule, the plurality of props 50 recorded in the account data can be transferred to the storage unit 13, and the plurality of props 50 recorded in the storage unit 13 can also be transferred to the account data. Moreover, functions and operation modes of the plurality of props 50, the display unit 11, the game result generating unit 12 and the storage unit 13 can be referred to the description in the first embodiment. In addition, a feasible solution for the rendering rule is to render a positively correlated quantity of the props 50 based on the consumption record, that is to say, the greater the consumption record, the greater a quantity of the props 50 rendered.

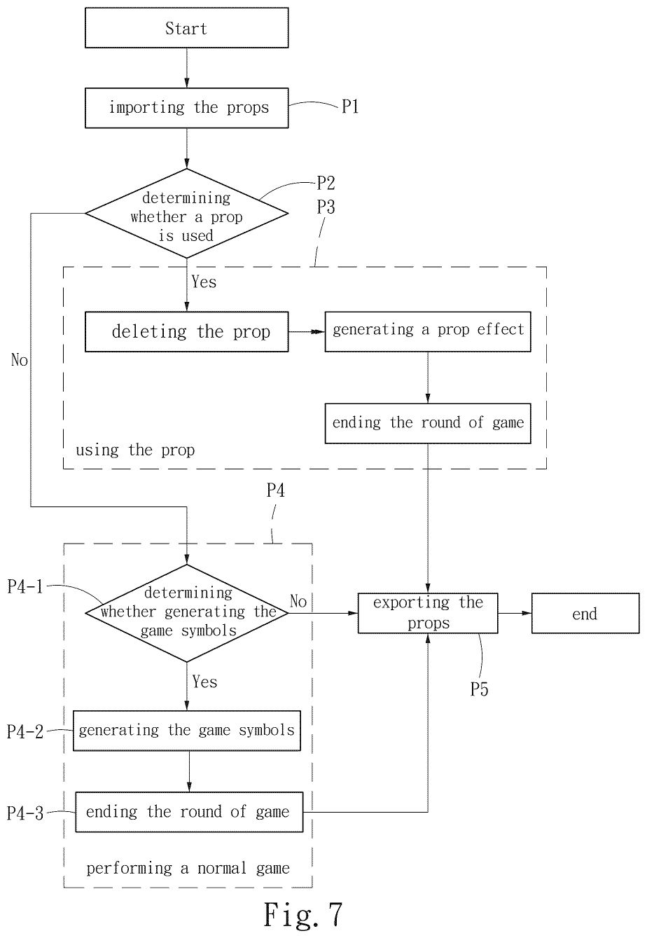

Please refer to FIG. 6 and FIG. 7. In the second embodiment, the control unit 14 is connected to the member management unit 15, the display unit 11, the game result generating unit 12 and the storage unit 13, and when the at least one round of game is performed in sequence, the control unit 14 performing following steps in each of the rounds of game.

Firstly, performing a step P1 of importing the props; in this step, transferring the plurality of props 50 recorded in the account data to the storage unit 13. Then, performing a step P2 of determining whether a prop is used; in this step, determining whether the player using at least one of the plurality of props 50 recorded in the storage unit 13, when the player uses at least one of the plurality of props 50 recorded in the storage unit 13, performing a step P3 of using the prop, and when the player does not use the plurality of props 50, performing a step P4 of performing a normal game. After ending the round of game, performing a step P5 of exporting the props. In this step, transferring the plurality of props 50 recorded in the storage unit 13 to the account data.

The step P3 of using the props is the same as the step S2 of using the props. Please refer to the description of the first embodiment.

In the step P4 of performing the normal game, the control unit 14 further performing following steps:
step P4-1: determining whether generating the game symbols. In this step, determining whether generating the plurality of game symbols 40 through the game result generating unit 12, if no, ending the round of game, if yes, proceeding to a next step;
step P4-2: generating the game symbols. In this step, generating the plurality of game symbols 40 through the game result generating unit 12; and
step P4-3: ending the round of game. In this step, paying out and ending the round of game.

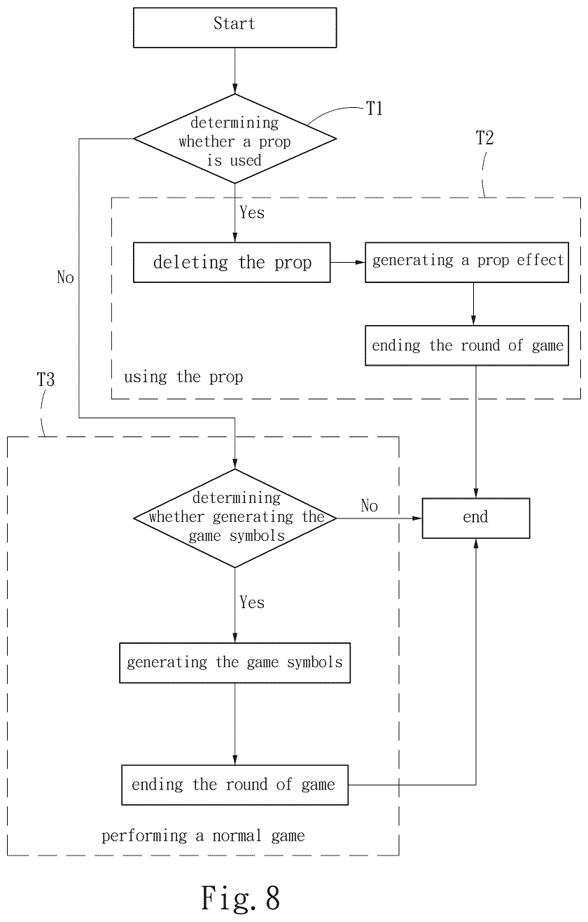

Please refer to FIG. 6 and FIG. 8. In a third embodiment of the invention, timings of transferring the plurality of props 50 recorded in the account data to the storage unit 13 and transferring the plurality of props 50 recorded in the storage unit 13 to the account data are different from the second embodiment. More specifically, the control unit 14 transfers the plurality of props 50 recorded in the account data to the storage unit 13 before a first round of the at least one round of game starts, and the control unit 14 transfers the plurality of props 50 recorded in the storage unit 13 to the account data after a last round of the at least one round of game ends.

In the third embodiment, when the at least one round of game is performed in sequence, the control unit 14 performs following steps in each of the rounds of game. Performing a step T1 of determining whether a prop is used; in this step, determining whether the player using at least one of the plurality of props 50 recorded in the storage unit 13; and when the player uses at least one of the plurality of props 50 recorded in the storage unit 13, performing a step T2 of using the prop, and when the player does not use the props 50, then performing step T3 of performing a normal game.

In the third embodiment, the step T2 of using the props and the step T3 of performing the normal game are respectively the same as the step P3 of using the props and step P4 of performing the normal game in the second embodiment, which can be referred to the description in the second embodiment.

Summing up the above, advantages of the invention at least comprise:
1. The invention is capable of collecting the props with the different specified game effects, and enables the player to freely choose use time according to needs to avoid breakpoints in the game, so the player will wait for an optimal use time, thereby providing an effect of using the game system continuously, and effectively increasing a turnover of the game system.
2. Through a game mode of enabling the player to collect the props, varied gameplays can be formed to attract the player and prevent the player from feeling bored.
3. The collected props can be stored in the member account, which can increase the player's desire to play in sporadic time and effectively increase a usage rate of the game machine.

What is claimed is:

1. A game system capable of determining use time, wherein the game system provides a slot game which provides at least one round of game for a player to play based on an operation of the player, the game system comprising:
a display unit, provided with a game screen displaying a real-time game image of the at least one round of game, and the game screen having a plurality of display positions arranged in matrices;
a game result generating unit, generating a plurality of game symbols in the at least one round of game, wherein the plurality of game symbols are displayed at the plurality of display positions of the game screen, the plurality of game symbols are provided with any one of a plurality of props according to a probability, and each of the plurality of props has a specified game effect;
a storage unit, configured to record any one of the plurality of props generated in the at least one round of game; and
a control unit, connected to the display unit, the game result generating unit and the storage unit, and when the at least one round of game performed in sequence, the control unit performing following steps in each round of game:
performing a step of determining whether at least one of the plurality of props recorded in the storage unit is used; and
performing a step of using the at least one of props when the player using at least one of the plurality of props recorded in the storage unit, and performing a step of performing a normal game when the player being not using the props;
in the step of using the at least one of the plurality of props, the control unit further performing following steps:
deleting the at least one of the plurality of props in the storage unit;
generating the specified game effect corresponding to the prop which is used, and generating the game symbols through the game result generating unit simultaneously; and
paying out and ending the round of game;
in the step of performing the normal game, the control unit further performing following steps:
determining whether generating the plurality of game symbols through the game result generating unit, if no, ending the round of game, if yes, proceeding to a next step;
generating the plurality of game symbols through the game result generating unit;
determining whether any one of newly generated game symbols having at least one of the plurality of props, if yes, performing a step of recording the at least one of the plurality of props of the newly generated game symbols through the storage unit, if no, proceeding to a next step; and
paying out and ending the round of game.

2. The game system as claimed in claim 1, wherein a member account of the player comprises an account data to record the plurality of props, and the control unit transfers the plurality of props recorded in the account data to the storage unit before a first round of the at least one round of game starts, and the control unit transfers the plurality of props recorded in the storage unit to the account data after a last round of the at least one round of game ends.

3. The game system as claimed in claim 1, wherein a member account of the player comprises an account data to record the plurality of props, and the control unit transfers the plurality of props recorded in the account data to the storage unit during each round of game, and the control unit transfers the plurality of props recorded in the storage unit to the account data when each round of game ends.

4. The game system as claimed in claim 1, wherein when a specified rule is determined to be satisfied in the slot game by the control unit, at least one of the plurality of props is provided to the player and is recorded in the storage unit.

5. The game system as claimed in claim 1, wherein the game result generating unit is a plurality of roller units, and the plurality of roller units generate the plurality of game symbols by spinning and then stopping.

6. A game system capable of determining use time, wherein the game system providing a slot game which provides at least one round of game for a player to play based on an operation of the player, the game system comprising:
a member management unit, configured to establish a member account of the player, wherein the member account comprises a consumption record and an account data of the player, and the member management unit selects at least one of a plurality of props to be stored in the account data based on the consumption record and a rendering rule, the plurality of props respectively have a specified game effect;
a display unit, provided with a game screen displaying a real-time game image of the at least one round of game, and the game screen having a plurality of display positions arranged in matrices;
a game result generating unit, generating a plurality of game symbols in the at least one round of game, wherein the plurality of game symbols is displayed at the display positions of the game screen;
a storage unit, the plurality of props recorded in the account data being transferred to the storage unit, and the plurality of props recorded in the storage unit being transferred to the account data; and
a control unit, connected to the member management unit, the display unit, the game result generating unit and the storage unit, and when the at least one round of game performed in sequence, the control unit performing following steps in each round of game:
transferring the plurality of props recorded in the account data to the storage unit;
performing a step of determining whether at least one of the plurality of props recorded in the storage unit is used;
performing a step of using the at least one of props when the player using at least one of the plurality of props recorded in the storage unit, and performing a step of performing a normal game when the player being not using the props; and
transferring the props recorded in the storage unit to the account data after ending the round of game;
in the step of using the at least one of the plurality of props, the control unit further performing following steps:
deleting the at least one of the plurality of props in the storage unit;
generating the specified game effect corresponding to the prop which is used, generating the game symbols through the game result generating unit simultaneously; and
paying out and ending the round of game;
in the step of performing the normal game, the control unit further performing following steps:
determining whether generating the plurality of game symbols through the game result generating unit, if no, ending the round of game, if yes, proceeding to a next step;
generating the plurality of game symbols through the game result generating unit; and
paying out and ending the round of game.

7. The game system as claimed in claim 6, wherein the rendering rule renders a positively correlated quantity of the props based on the consumption record.

8. The game system as claimed in claim 6, wherein the game result generating unit is a plurality of roller units, and the plurality of roller units generate the plurality of game symbols by spinning and then stopping.

9. A game system capable of determining use time, wherein the game system providing a slot game which provides at least one round of game for a player to play based on an operation of the player, the game system comprising:
a member management unit, configured to establish a member account of the player, wherein the member account comprises a consumption record and an account data of the player, and the member management unit selects at least one of a plurality of props to be stored in the account data based on the consumption record and a rendering rule, the plurality of props respectively have a specified game effect;
a display unit, provided with a game screen displaying a real-time game image of the at least one round of game, and the game screen having a plurality of display positions arranged in matrices;
a game result generating unit, generating a plurality of game symbols in the at least one round of game, wherein the plurality of game symbols is displayed in at the display positions of the game screen;
a storage unit, the plurality of props recorded in the account data being transferred to the storage unit, and the plurality of props recorded in the storage unit being transferred to the account data; and
a control unit, connected to the member management unit, the display unit, the game result generating unit and the storage unit, and the control unit transferring the plurality of props recorded in the account data to the storage unit before a first round of the at least one round of game starting, and the control unit transferring the plurality of props recorded in the storage unit to the account data after a last round of the at least one round of game ending, and when the at least one round of game being performed in sequence, the control unit performing following steps in each round of game:
performing a step of determining whether at least one of the plurality of props recorded in the storage unit is used; and
performing a step of using the at least one of props when the player using at least one of the plurality of props recorded in the storage unit, and performing a step of performing a normal game when the player being not using the props;
in the step of using the at least one of the plurality of props, the control unit further performing following steps:
deleting the at least one of the plurality of props in the storage unit;
generating the specified game effect corresponding to the prop which is used, and generating the game symbols through the game result generating unit simultaneously; and
paying out and ending the round of game;
in the step of performing the normal game, the control unit further performing following steps:
determining whether generating the game symbols through the game result generating unit, if no, ending the round of game, if yes, proceeding to a next step;
generating the plurality of game symbols through the game result generating unit; and
paying out and ending the round of game.

10. The game system as claimed in claim 9, wherein the rendering rule renders a positively correlated quantity of the props based on the consumption record.

11. The game system as claimed in claim 9, wherein the game result generating unit is a plurality of roller units, and the roller units generate the game symbols by spinning and then stopping.
